(19) United States
(12) Patent Application Publication
(10) Pub. No.: US 2023/0398866 A1
(43) Pub. Date: Dec. 14, 2023

(54) SYSTEMS AND METHODS FOR HEADS-UP DISPLAY

(71) Applicant: Motional AD LLC, Boston, MA (US)

(72) Inventor: Amitai Y. Bin-Nun, Pittsburgh, PA (US)

(21) Appl. No.: 17/836,033

(22) Filed: Jun. 9, 2022

(51) Int. Cl. B60K 35/00; G06F 3/14; G02B 27/01

(52) U.S. Cl. CPC B60K 35/00; G06F 3/14; G02B 27/0101; G02B 2027/0141; B60K 2370/177; G02B 2027/014; B60K 2370/1529

(57) ABSTRACT

Provided are methods for systems and methods for heads-up display, which can include obtaining sensor data, determining a plurality of trajectories and evaluating them. The methods can further include generating trajectory data which can then be provided to a user associated with the vehicle. The methods can be used for autonomous vehicles and non-autonomous vehicles. Systems and computer program products are also provided.

### BACKGROUND

Traffic laws can be complex and can vary between jurisdictions. These laws are frequently breached by human operators of vehicles for a variety of reasons, such as an inadequate recollection of the traffic laws. Currently many drivers and passengers rely heavily on road signage and their recollection of studying for their driving exams to inform the legality of their driving with only very rudimentary information provided to them by the vehicle instrumentation.

### BRIEF DESCRIPTION OF THE FIGURES

FIG. 1 is an example environment in which a vehicle including one or more components of an autonomous system can be implemented;

FIG. 2 is a diagram of one or more example systems of a vehicle including an autonomous system;

FIG. 3 is a diagram of components of one or more example devices and/or one or more example systems of FIGS. 1 and 2;

FIG. 4 is a diagram of certain components of an example autonomous system;

FIGS. 5A-5D are diagrams of an example implementation of a system for heads-up display;

FIGS. 6A-B are diagrams of an example implementation of a system for heads-up display; and

FIG. 7 is a flowchart of an example process for systems and methods for heads-up display.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a method for heads-up display. The method includes obtaining, using at least one processor, sensor data associated with an environment in which a vehicle is operating. The method includes determining, using the at least one processor, based on the sensor data, a plurality of trajectories for the vehicle. The method includes evaluating, using the at least one processor, based on a rule parameter, a score of a trajectory of the plurality of trajectories, wherein the rule parameter is indicative of one or more rules for operating the vehicle. The method includes generating, using the at least one processor, based on the score, trajectory data associated with a candidate trajectory of the plurality of trajectories. The method includes causing, using the at least one processor, a device to provide an output, to a user associated with the vehicle, based on the trajectory data associated with the candidate trajectory.

By virtue of the implementation of systems, methods, and computer program products described herein, techniques for providing a user with additional information regarding the trajectory of the vehicle, which can be used in the interaction of the user with the vehicle, e.g. via a continued and/or guided human-machine interaction process. Some advantages of these techniques include improving the support of a driver in operating the vehicle, e.g. by performing the technical task of driving the vehicle. Some advantages of these techniques include providing a user with additional information regarding the trajectory of the vehicle (e.g., a vehicle equipped with an advanced driver assistance system, a vehicle equipped with an autonomous system, and/or the like), which can be used in the interaction of the user with the vehicle, e.g. via a continued and/or guided human-machine interaction process. For example, the user is provided with underlying information, e.g. a dynamic internal state of the vehicle, that leads to the trajectory of the vehicle. By virtue of implementation of certain techniques described herein, the user is conveyed information indicative of the internal operation of an autonomous vehicle (AV) (e.g. as to why the AV behaves as it does), which can improve the interaction of the user with AVs.

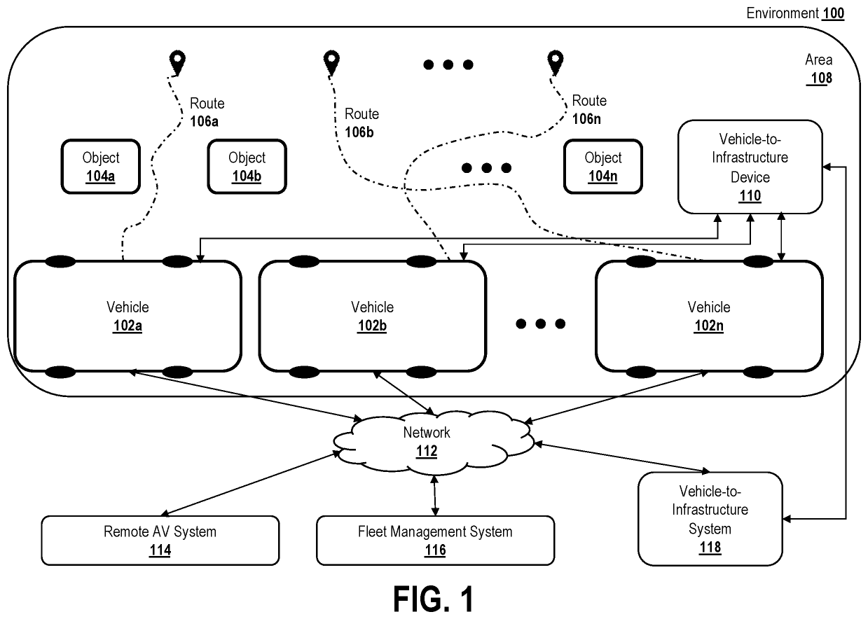

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

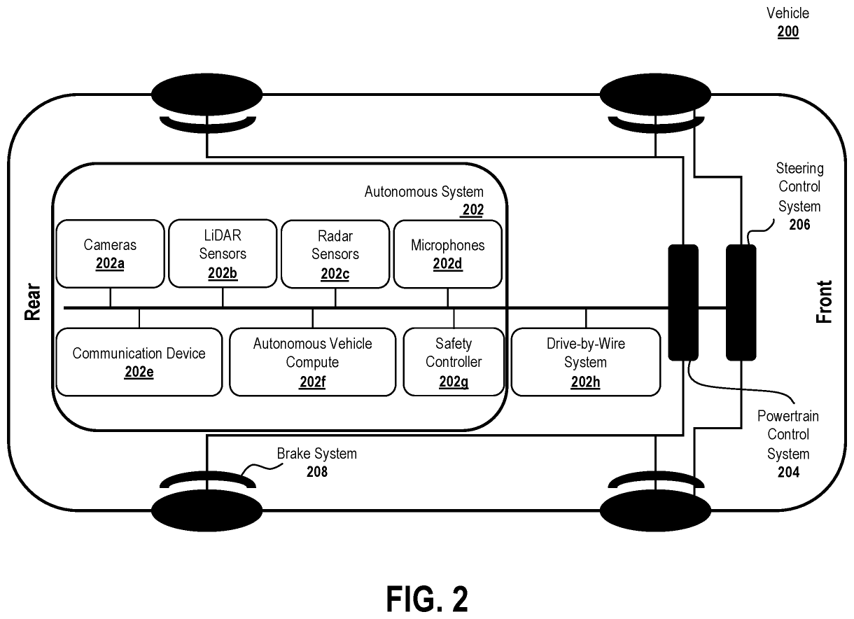

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

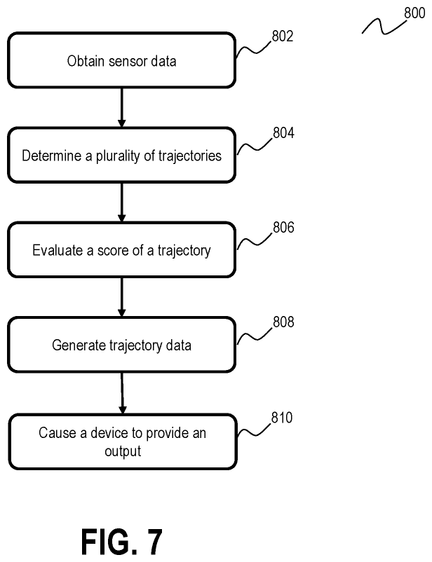

In some embodiments, device 300 is configured to execute software instructions of one or more steps of the disclosed method, as illustrated in FIG. 7.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

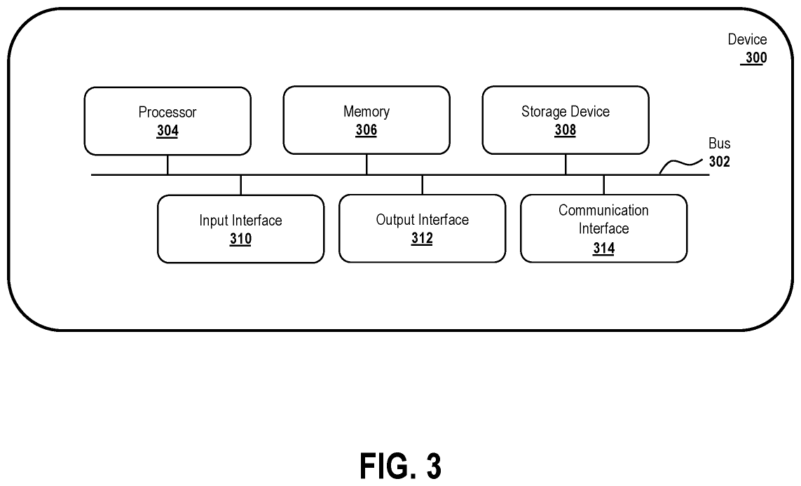

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

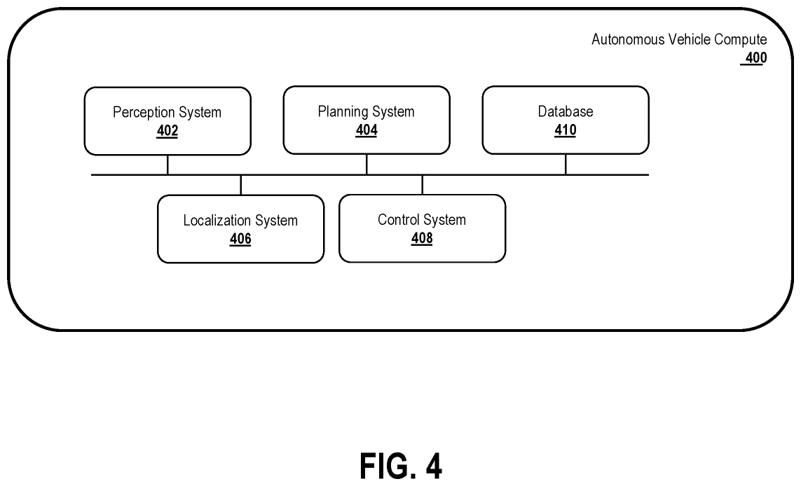

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

The present disclosure relates to systems, methods, and computer program products that provide for providing of information and/or guidance to users during operation of a vehicle, such as displaying via a heads-up display and/or providing auditory notifications. Currently, most drivers and passengers rely almost exclusively on road signage and their recollection of studying for driving exams to understand legal behaviors, with only very rudimentary information provided to them by the vehicle instrumentation (e.g., speed limits on navigation screens). Advantageously, the disclosed systems, methods, and computer program products can obtain and display more information than a user would typically know, such as complex and varying traffic laws.

For example, at a given point in time, the vehicle is configured to put together a detailed understanding of the world, and a planning system, such as planning system 404 of FIG. 4, can generate candidate trajectories representing plausible choices for the vehicle to take. The candidate trajectories can be evaluated by a set of rules for specific properties, such as one or more of legality (e.g., a binary legal or not legal), and overall score, and safety. These rankings, in some examples, are communicated to a user of the vehicle, such as through color-coding different trajectories according to their score.

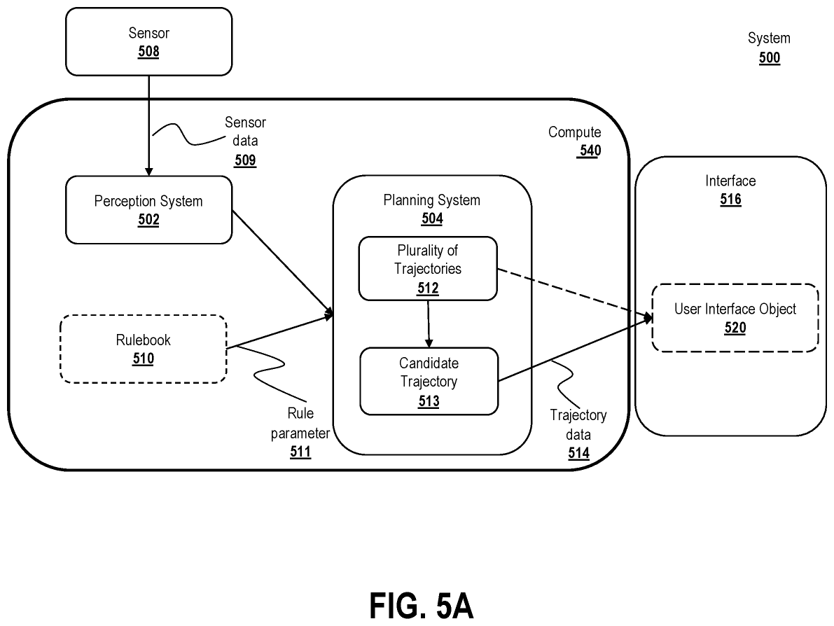

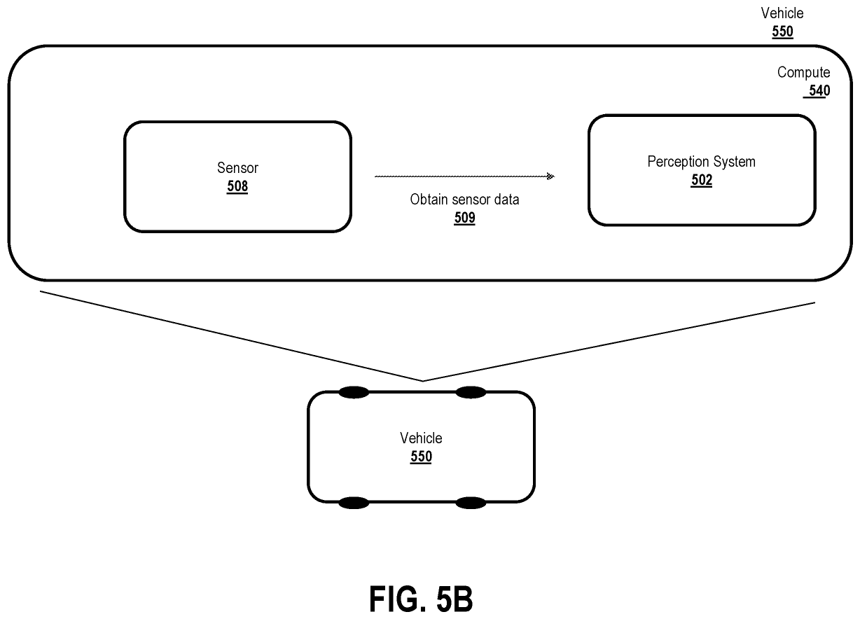

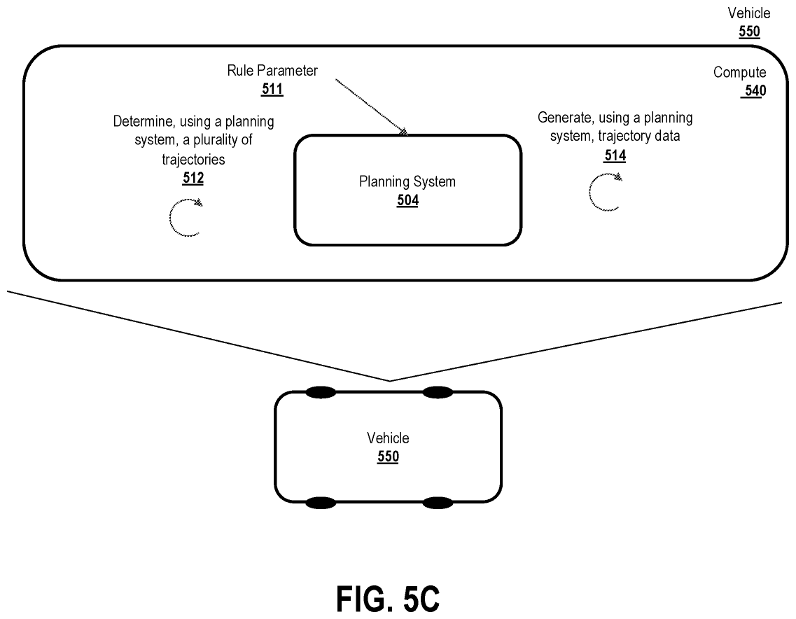

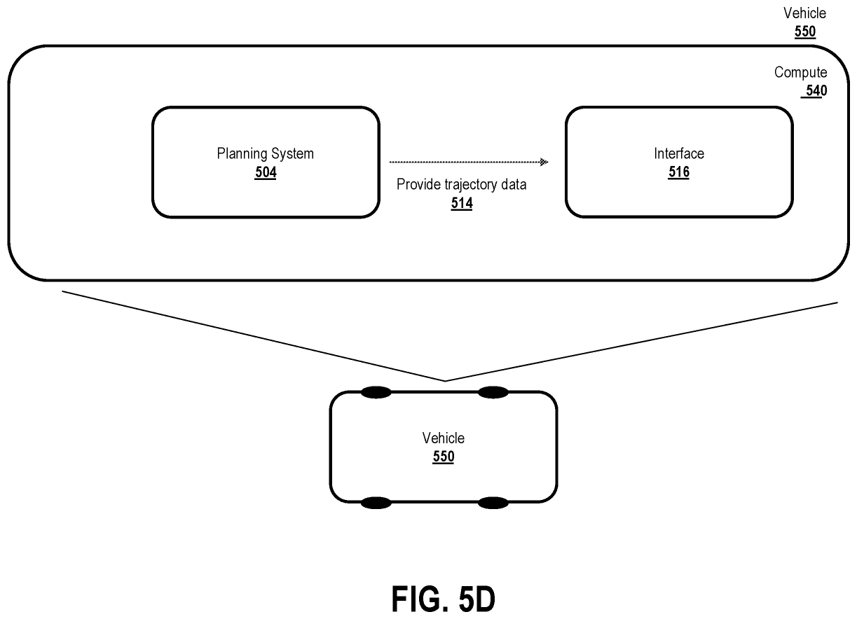

Referring now to FIGS. 5A-5D, illustrated are diagrams of an implementation of a system 500 for heads-up display of a vehicle 550. In some embodiments, the system 500 includes a vehicle compute 540 (such as similar to AV compute 202f of FIG. 2 and/or AV compute 400 of FIG. 4), and a vehicle 550 (similar to vehicle 102 of FIG. 1 and/or vehicle 200 of FIG. 2, such as an autonomous vehicle). In one or more examples or embodiments, the system 500 is an autonomous vehicle (e.g., illustrated as vehicle 102 and 200 in FIGS. 1 and 2, respectively), an autonomous system (similar to autonomous system 202 of FIG. 2 and/or one or more components of autonomous system 202), a device (similar to device 300 of FIG. 3), a remote AV system, a fleet management system, and/or a V2I system. The system 500 can be for operating an autonomous vehicle. The system 500 may not be for operating an autonomous vehicle, such as for use in non-autonomous vehicles.

In one or more embodiments or examples, the system 500 is configured to utilize one or more sensors, such as sensor 508, of a vehicle 550, such as one or more cameras 202a, one or more LiDAR sensors 202b, and/or one or more radar sensors 202c of autonomous vehicle 200 of FIG. 2. Further, the system 500 can be configured to provide different sorts of displays, such as utilizing one or more of an output interface and communication interface of a vehicle 550, for example using the output interface 312 and communication interface 314 of FIG. 3. Certain data (e.g., sensor data 509, trajectory data 514, rulebook 510, information) can be stored in a database, such as database 410 of FIG. 4 and/or storage device 308 of FIG. 3.

In one or more embodiments or examples, the system 500 includes one or more of a planning system 504, a perception system 502 that are the same as, or similar to, the planning system 404 and the perception system 402 of FIG. 4 respectively.

Disclosed herein is a system 500. The system 500 includes at least one processor. The system 500 includes at least one memory storing instructions thereon that, when executed by the at least one processor, cause the at least one processor to perform operations including obtaining sensor data 509 associated with an environment in which a vehicle 550 is operating. The operations include determining, based on the sensor data 509, a plurality of trajectories 512 for the vehicle 550. The operations include evaluating, based on a rule parameter 511, a score of a trajectory of the plurality of trajectories 512, wherein the rule parameter 511 is indicative of one or more rules for operating the vehicle 550. The operations include generating, based on the score, trajectory data 514 associated with a candidate trajectory 513 of the plurality of trajectories 512. The operations include causing a device to provide an output, to a user associated with the vehicle 550, based on the trajectory data 514 associated with the candidate trajectory 513.

In one or more examples, the system 500 is incorporated into a non-autonomous vehicle. For example, the system 500 is used to provide guidance to an operator and/or a passenger of a vehicle. In one or more examples, the system 500 is incorporated into an autonomous vehicle. For example, the system 500 is used for operation of the autonomous vehicle. The system 500 of an autonomous vehicle can also be used to provide guidance to an operator and/or a passenger of the autonomous vehicle.

In one or more examples or embodiments, the system 500 is configured to determine information about the environment that the vehicle is operating in and provide relevant information to a user of the vehicle. The relevant information can range from trajectory information resulting from traffic laws to information due to area customs and/or parking information. As an example, the system 500 determines a plurality of trajectories 512 for the vehicle 550, such as a plurality of potential trajectories. The system 500 then, based on a rule parameter 511, evaluates the trajectories, and gives the trajectories a score in one or more examples. The rule parameter 511 can be based on a rulebook 510 that represents rules for operating vehicles (such as including the “rules of the road”) in a hierarchical structure, for a particular location that the system 500 is located in. For example, the system 500 then generates trajectory data 514 associated with at least one trajectory, such as a candidate trajectory 513, of the plurality of trajectories 512. In one or more embodiments or examples, the system 500 provides information relevant to the candidate trajectory 513 (e.g., trajectory data 514). This trajectory data 514 can be one or more of many types of data that can be provided to a user, such as visual data or auditory data. The trajectory data 514 provides, in some examples, guidance to a user of the vehicle 550. The trajectory data 514, for example, provides relevant information to a user for operation of the vehicle 550. As an example, the trajectory data 514 is indicative of what areas should or should not be driven on, delineates of areas that are not legal to drive in, rules of the road, yielding, etc., as will be discussed in detail below.

In one or more embodiments or examples, the system 500 polls trajectories that are generated (periodically or continuously) by the planning system 504, scoring at least a subset of these trajectories, and then displaying (either directly or by representation) the score of each of the trajectories to a user operating the vehicle 550. Examples may include scores for switching lanes, turning, slowing down, speeding up, etc. So, at any given moment, the user can obtain information regarding operations of the vehicle (such as whether operations like switching lanes, overtaking cars, etc., are performed due to the traffic rules).

In one or more examples or embodiments, the system 500 obtains sensor data 509 from a sensor 508, such as via perception system 502 as shown in FIG. 5B. The system 500 can use sensor data 509 for the determination of the plurality of trajectories 514. The sensor data 509 can be one or more of: radar sensor data, image sensor data (e.g. camera sensor data), audio sensor data, and LIDAR sensor data. The particular type of sensor data 509 is not limiting. The sensor data 509 can be indicative of an environment around the vehicle 550. For example, the sensor data 509 can be indicative of an object, and/or a plurality of objects, in the environment in which the vehicle 550 operates.

The sensor, such as sensor 508, can be one or more sensors, such as an onboard sensor. The sensor 508 may be associated with the vehicle 550. The vehicle 550 may include one or more sensors that can be configured to monitor an environment where the vehicle operates, such as via the sensor 508, through sensor data 509. For example, the monitoring can provide sensor data 509 indicative of what is happening in the environment around the vehicle 550, such as for determining trajectories of the vehicle 550. The sensor 508 can be one or more of: a radar sensor, a camera sensor, a microphone, an infrared sensor, an image sensor, and a LIDAR sensor. The sensor 508 can include one or more of the sensors illustrated in FIG. 2, such as cameras 202a, LiDAR sensors 202b, radar sensors 202c, and microphones 202d.

In one or more embodiments or examples, the sensor data 509 is indicative of the environment, which may be roads, areas, surfaces, towns, cities, countries where the vehicle 550 is, such as is operating (e.g., driving) in and/or is located in. The environment can include any number of aspects, including signage, infrastructure, etc. In one or more embodiments or examples, the environment includes non-transitory objects.

In one or more examples and embodiments, the system 500 is configured to obtain location data of the vehicle 550, such as through a localization system 406 discussed in FIG. 4. This may allow the system 500 to obtain a different rule parameter 511 (e.g., from rulebook 510) of the particular area the vehicle 550 is in. For example, the rule parameter in a first location may be indicative of different rules than a rule parameter of a second location, such as due to changing road laws. The system 500 can be configured to obtain a different rule parameter 511 from the rulebook 510 depending on the location of the vehicle 550. In some embodiments, the planning system 504 can access data including rules (e.g., rule parameter 511) used for planning. For example, rules (e.g., as indicated by the rule parameter 511) are specified using a formal language, e.g., using Boolean logic. In some examples, the rules are rules of the road, rules of passenger comfort, and/or rules of expression. In some examples, rules of the road define whether or not a particular maneuver is permitted in the lane of travel of the vehicle and/or the environment of the vehicle. For example, the rulebook 510 can include a rule parameter 511 indicating that changing lanes is prohibited in construction zones. In turn, the system 500, based on the rule parameter 511, will not score high a trajectory with a lane change and thereby not perform a maneuver that requires a lane change. In some examples, rules of passenger comfort define whether or not a particular passenger within the vehicle has motion sickness and is sensitive to high gravitational force equivalents (‘g’ forces). In a situation encountered by the vehicle, at least some of the rules may apply to the situation. Rules can have priority (e.g., can be associated with a priority level and/or score). For example, a rule that says, “if the road is a freeway, move to the leftmost lane” can have a lower priority than “if the exit is approaching within a mile, move to the rightmost lane.”

In one or more embodiments or examples, the system 500 determines a plurality of trajectories 512 of the vehicle 550, such as via planning system 504. The system 500 obtains the sensor data 509, and in one or more examples or embodiments the planning system 504 uses the sensor data 509 for the determination of any agents in the environment. Further, the system 500 can use a localization system (such as localization system 406 of FIG. 4) to determine where the vehicle is located. Based on, optionally, the localization of the vehicle determined by the localization system, and the sensor data 509, the system 500 can determine one or more trajectories (such as the plurality of trajectories 512), so that the vehicle will not adversely encounter one or more agents in the environment. In one or more examples or embodiments, the system 500 purely determines potential trajectories, and does not make any evaluation of the legality or possibility of the trajectories until an evaluation step. Further, the system 500, for example, determines trajectories that will follow the normal rules of the road, such as staying within lanes. In one or more examples or embodiments, the system 500 predicts trajectories of agents in the environment, and the system determines a plurality of trajectories 512 that do not intersect with the trajectories of the agents. In other words, the system 500 can be configured to obtain sensor data 509 and, optionally, localization data, for the determination of a plurality of trajectories 512.

The plurality of trajectories 512, in some examples, are candidate trajectories that a driver might choose at the current point in time. The plurality of trajectories 512 can include any number of trajectories, and the particular number is not limiting. In some instances, a single trajectory may be determined for the vehicle 550, such as when there is only a single potential legal and/or safe trajectory. In one or more embodiments or examples, the system 500 determines a trajectory of the vehicle 550.

A trajectory can be seen as one or more maneuvers that can be accomplished by the vehicle 550. In one or more examples or embodiments, a trajectory includes a series of states such as a current position, intermediate positions, and/or a target position, associated with parameters (e.g., time and velocity). This can be, for example, a lane-level trajectory. In one or more examples or embodiments, a trajectory is different from a route. A plurality of trajectories, typically a very large number of trajectories, can form a route. In other words, trajectories can be limited in time, moment to moment actions, as opposed to a route which indicates long term.

In one or more embodiments or examples, determining the plurality of trajectories 512 includes determining the plurality of trajectories every 30 seconds or less. The system 500, for example, determines the pluralities of trajectories 512 every 30, 25, 20, 15, 10, or 5 seconds or less. This can be compared to a route determination, which occurs much less frequently, such as only when an action significantly changes the route. The system 500 can continuously determine the plurality of trajectories 512, which can be advantageous for providing continuously updated information to the user.

In one or more embodiments or examples, the system 500 is configured to evaluate each of the trajectories of the plurality of trajectories 512. The system 500, for example, obtains the plurality of trajectories 512 and evaluates each of the plurality of trajectories 512 for output of a candidate trajectory 513 and/or the score. In one or more examples or embodiments, the candidate trajectory 513 is seen as the “best” trajectory of the plurality of trajectories, based on rules as indicated by the rule parameter 511.

For example, the system 500 evaluates a score (discussed below) of each trajectory based on a rule parameter 511. The rule parameter 511 can be obtained by the system 500, such as from a memory and/or database (such as database 410 of FIG. 4). The rule parameter 511 can be stored in the system 500. In one or more embodiments or examples, the system 500 obtains the rule parameter 511 periodically. This can allow the system 500 to have the proper rule parameter 511 for the particular location that the vehicle 550 is in. The system 500 can be configured to obtain the rule parameter 511 at certain known delineations, such as crossing of state and/or country borders, entering or leaving towns and/or cities, etc.

In one or more examples or embodiments, the system 500 is configured to evaluate each trajectory of the plurality of trajectories 512 for provision of a score. In one or more examples or embodiments, the score is a representative numeric value of a particular trajectory based on the rule parameter 511. The score may be an overall score, which in some examples is used to evaluate the legality and/or the safety of the plurality of trajectories. The score may be indicative of values of a particular trajectory, such as based on complying with certain rules indicative by the rule parameter 511. In one or more examples or embodiments, the score is based on user preferences as well, such as fuel efficiency, environmental impact, speed, etc. The system 500, in some examples, selects a candidate trajectory 513 of the plurality of trajectories 512 which has the lowest score.

For example, the system 500 is configured to evaluate each trajectory of the plurality of trajectories 512 based on the rule parameter 511. The system 500 is configured, in some examples, to provide a numerical evaluation (e.g., score) of each trajectory of the plurality of trajectories 512, based on any violations of the rule parameter 511. For example, the system 500 can be configured to give a “point” (e.g., as the score) to a trajectory for each rule it violates. In one or more examples or embodiments, after evaluating each trajectory, the system 500 selects the trajectory of the plurality of trajectories 512 having the lowest point total (e.g., the lowest score), which indicates the lowest violation of rules. The trajectory with the lowest score can be the candidate trajectory 513.

The system 500, in certain examples, obtains the rule parameter 511 from a rulebook 510 (e.g., the rule parameter 511 is based on the rule book), which may include a set of rule parameters associated with a list of respective rules and respective data indicative of such rules. The rulebook 510 may contain a plurality of rule parameters, and the system 500 can obtain the rule parameter 511 relevant to the particular location of the vehicle 550.

Rules, indicated by the rule parameter 511, include aspects of operating the vehicle 550, such as staying within particular distances of other agents in the environment, speed limits, what areas can be driven on, whether or not lane changes are allowed, whether or not overtaking is allowed, where stopping, standing, or parking is allowed, whether the driver needs to yield to cross-traffic, parking areas, etc. The rule parameter 511 can vary depending on the jurisdiction (e.g., country, city, location) that the vehicle 550 is operating in. In one or more examples or embodiments, the rule parameter 511 is indicative of one or more of rules of the road, rules of passenger comfort, and rules of expression. For example, the rule parameter 511 is indicative of legal and/or customary rules. The rule parameter 511 can be set by the manufacturer of the vehicle 550.

In one or more examples or embodiments, the system 500 is configured to generate, based on the score, trajectory data 514, such as shown in FIG. 5C. The system 500 can output the trajectory data 514, such as to an interface 516 as shown in FIG. 5D. For example, the system 500 obtains the score and the candidate trajectory 513 having the lowest score. The system 500 can then obtain relevant data regarding the candidate trajectory 513, such as one or more of sensor data 509, the rulebook 510 and the rulebook parameter 511. Based on all the obtained data, the system, in one or more examples or embodiments, generates trajectory data 514 which may be relevant for a user of the vehicle. The system 500 can obtain user input on the type of trajectory data 514 the user may want to receive. The system 500 can generate trajectory data 514 based on the user input. The system 500 can generate different types of trajectory data 514

The system 500, in some examples, uses localization data and/or sensor data 509 for determination of what type of trajectory data 514 to generate. For example, if the system 500 obtains sensor data 509 indicative of nearby parking spaces, the system 500 generates trajectory data 514 relevant to parking. As another example, when the localization data and/or sensor data 509 indicates that the vehicle is travelling at high speeds on a highway, the system 500 is configured to generate trajectory data 514 relevant to this action, and not to parking. In one or more examples or embodiments, the system 500 is configured to use the score and the candidate trajectory 513 for determining what trajectory data 514 to generate, and may not use the localization data and/or the sensor data 509.

The system 500, in certain embodiments, determines whether sensor data 509 and/or localization data meets one or more trajectory criteria. The trajectory criteria can be indicative of actions taken by the vehicle. As an example, trajectory criteria can include parking criteria, highway criteria, local traffic criteria, etc. Each trajectory criteria may have associated trajectory data 514. Upon determining that the sensor data 509, the localization data, the score, and/or the candidate trajectory 513 meets one or more of the trajectory criteria, the system 500 can be configured to generate trajectory data 514 associated with the met trajectory criteria. Upon determining that the sensor data 509, the localization data, the score, and/or the candidate trajectory 513 does not meet one or more of the trajectory criteria, the system 500 can be configured to not generate trajectory data 514 associated with the met trajectory criteria.

In one or more examples or embodiments, the trajectory data 514 is associated with a candidate trajectory 513 (e.g., a potential trajectory) of the plurality of trajectories 512. A candidate trajectory 513, in some examples, is an allowable potential trajectory which has been evaluated against the rule(s) indicated by the rule parameter 511. The trajectory data 514 can be indicative of one or more actions that can be taken by the vehicle 550. As mentioned, the trajectory data 514 can encompass analysis of different environmental, such as localization, rules based on the rule parameter 511.

In one or more embodiments or examples, generating the trajectory data 514 includes generating, based on the score and the sensor data 509, the trajectory data 514. Accordingly, the trajectory data 514 can be based on the score and sensor data 509. This can include real-time sensor data, such as obtained by the vehicle 550 during operation of the vehicle 550. Advantageously, using sensor data 509 for the generation of trajectory data 514 can allow for transient agents in the environment to be registered and evaluated. The system 500, in certain examples, uses the sensor data 509 to provide a more complete environmental view for the user of the vehicle 550.

In one or more examples or embodiments, the system 500 is configured to cause a device to provide an output based on the trajectory data 514. The system 500 can perform such an action via an interface 516. In other words, the system 500 can be configured to provide guidance and/or information to a user of the vehicle 550. As an example, the output provides information whether certain potential trajectories are not legal or rated poorly, such as for safety reasons (e.g., a fast moving car approaching in a different lane). The type of device can include devices for providing a visual image and/or an auditory noise, and the output can be indicative of a particular visual image and/or sound, such as via interface 516. The device can be incorporated into the vehicle 550, or may be separate from the vehicle 500, such as a smart phone of an operator and/or of passenger of a vehicle 550.

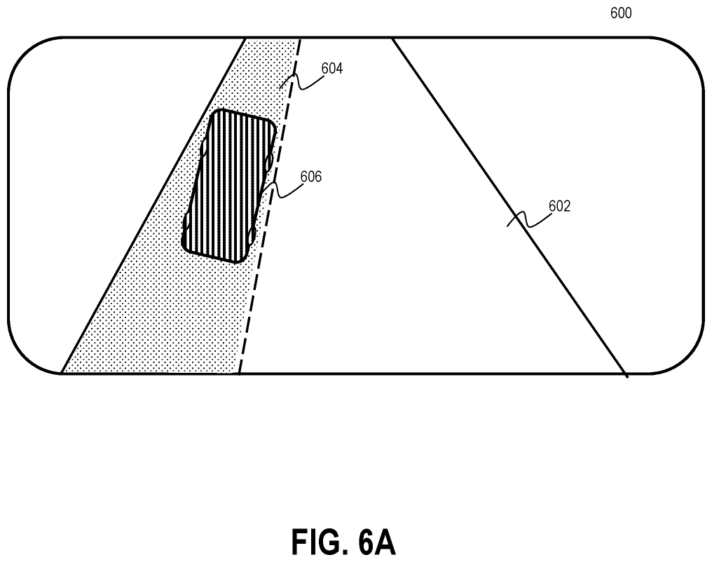

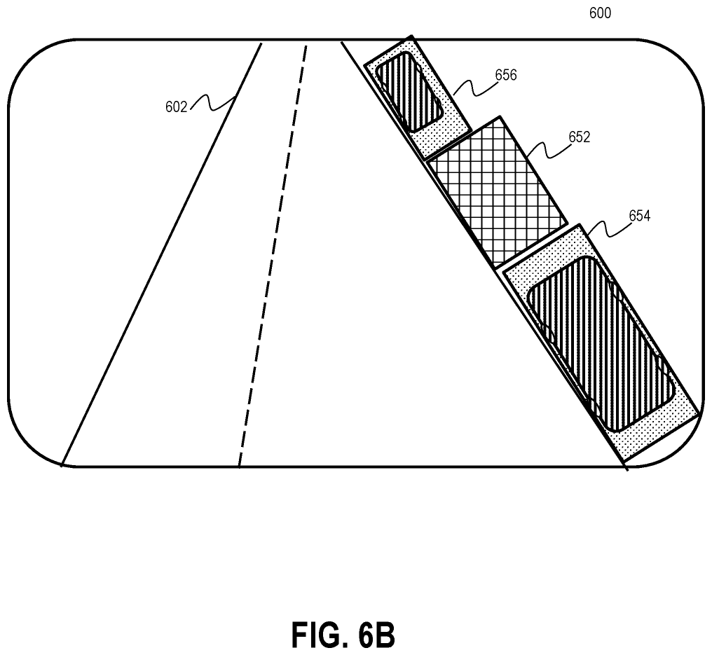

In one or more embodiments or examples, causing the device to provide the output, to the user, based on the trajectory data 514 includes causing the device to display a user interface object 520 representative of the trajectory data 514 to the user. The user interface object 520 can be indicative of any number of display information. Display information can include one or more of route information, driving information, traffic information, speed limits, intersections, legal parking areas, legal turning areas, etc. Examples of a user interface object include 520 icons, notifications to be presented, shading, colors, legality information, percentages, etc. The user interface object 520 can be a visual symbol providing some sort of information and guidance to a user of the vehicle 550. FIGS. 6A-6B provide various examples of user interfaces including the disclosed user interface object.

In one or more embodiments or examples, the user interface object 520 is representative of an action that can or cannot be taken by the vehicle 550. The system 500 is configured to overlay the user interface object 520, in some examples, on the road in a user's field of view so that a user can see both the road and the user interface object 520.

For example, if the system 500 determines that a car is approaching in a lane to the left, the user interface object 520 can show a red shaded lane to the user. This may indicate that the vehicle 550 may not enter the lane to the left. Once the car has passed, the user interface object 520 may turn green, indicating that it is safe to change lanes. As another example, the user interface object 520 is a red shaded lane for traffic moving the opposite way. As it would be illegal for the vehicle 550 to enter the lane, as indicated by the rule parameter 511, it may always be shaded red.

Different user interface objects can be used by the system 500 to provide any useful information to a user. In one or more embodiments or examples, the user interface object 520 shows a speed of the current lane that the vehicle 550 is in. That way, a user would know the speed without having to rely on road signs, which may not be readily accessible. The system 500 can be configured to obtain a rule parameter 511 which is indicative of the speed limit for the current location that the vehicle 550 is operating in.

As another example, the user interface object 520 may be used for showing viability of parking spots for the vehicle 550. An open spot may be shaded one color, whereas non-open parking spots may be shaded a different color. Further, the system 500 can determine whether parking would be allowed at a certain location based on the rule parameter 511. Even if the location does not have any other vehicles, it may not be legal for the vehicle to park there, and thus the system 500 can provide a user interface object 520 indicative of no parking.

In one or more embodiments or examples, the user interface object 520 includes a color-coded user interface object and/or a pictogram. The user interface object 520 may be representative of the plurality of trajectories 512 that can be taken by the vehicle 550. Color-coding can be used to differentiate the trajectories based on their score. Color-coding can be used for delineation of areas or semantic purposes. In one or more embodiments or examples, a pictogram illustrates a vehicle, pedestrian, bicycle, etc. The pictogram, in some examples, is a representation of the environment that the vehicle 550 is in. While color-coding is discussed here, other types of visual cues can be used for the user interface object. Different patterns, hatching, etc. can differentiate different user interface objects, which may be particularly advantageous for color blind users.

FIGS. 6A-6B illustrate examples of user interface objects displayed on a windshield 600 of a vehicle (such as vehicle 550 of FIGS. 5B-5D and/or vehicle 200 of FIG. 2). As shown in FIG. 6A, a user would be able to see a road 602 of which the vehicle is operating in. Based on the trajectory data, the system 500 can be configured to display a first user interface object 604, which is displayed as a red-shaded lane. The system 500 can be configured to display a second user interface object 606, which is a vehicle. The second user interface object 606 may be overlayed on an actual vehicle in the environment, or may be shown to indicate to a user that a vehicle will be coming in the red-shaded lane indicated by the first user interface object 604. Alternatively, the vehicle shown by user interface object 606 may be the vehicle itself that a user could see, and not a user interface object. In another example, the first user interface object 604 is displayed as red as the rule parameter is indicative of a “no-passing zone” of the location the vehicle is in.

FIG. 6B illustrates further information that can be provided to a user. Similar to FIG. 6A, a user will be able to see a road 602 via the windshield 600 of the vehicle. Based on the trajectory data, the system 500 can be configured to display interface objects indicative of available parking spaces on the side of a road. For example, the system 500 is configured to display a first user interface object 652 indicative of an available parking space, such as via color-shading of the area. The first user interface object 652 can be green to indicate an available spot, or red, such as shown in second and third user interface objects 654 and 656, indicative of a non-available spot. The system 500 may be configured to use the rule parameter to determine whether the available parking spot, shown as first user interface object 652, is a legal place to park. The trajectory data can be indicative of whether the available spot is a legal parking spot.

In one or more embodiments or examples, the device is one or more of: a display device, an augmented reality device, a user device, and a projection device. The particular device is not limiting, any type of device that can provide a visual image to the user can be utilized. The device may be part of the vehicle 550. Display devices can include displays on a vehicle, such as a dashboard display. The device may be separate from the vehicle. The user device can be a user's personal device in data communication with a vehicle, such as a smart phone or tablet.

In one or more embodiments or examples, causing the device to provide the output, to the user, based on the trajectory data includes projecting the user interface object on a surface. For example, the system 500 projects the trajectory data 514 onto a surface of the vehicle 550. The system 500 can include a projector, for example, on a dashboard of the vehicle 550. In one or more embodiments or examples, the surface is one or more of a windshield of the vehicle 550, and a dashboard of the vehicle 550. The surface can be any surface that would be visually accessible by the user, while not hindering the user's ability to operate the vehicle 550, if necessary. As an example, the surface is a surface in the field of view of the user, such as a windshield.

In one or more embodiments or examples, causing the device to provide the output, to the user, based on the trajectory data 514 includes causing the device to display a second user interface object representative of one of the plurality of trajectories 512 to the user. For example, the system 500 displays a potential trajectory of the vehicle 500 with another user interface object 520. The second interface object can be indicative of a trajectory the vehicle 550 can take or cannot take. In FIG. 6A, another user interface object may show a red trajectory (merely an example, other indicators of a “bad” trajectory can be used) switching into the left lane with the approaching vehicle. An additional user interface object may show a green trajectory (merely an example, other indicators of a “green” trajectory can be used) proceeding straight.

In one or more embodiments or examples, causing the device to provide the output, to the user, based on the trajectory data 514 includes causing the device to generate an audible signal based on an audio message associated with the trajectory data. The audio message can be an audio sound including one or more of a: bell, whistle, alert. The audio message can be a message including text, such as a voice assisting message. The system 500, in some embodiments or examples, utilizes a combination of audio and visual notifications for the user.

In one or more examples or embodiments, the system 500 is configured to control, based on the trajectory data 514 and/or the candidate trajectory 513, the operation of vehicle 550, such as when then vehicle 550 is an autonomous vehicle. Controlling the operation, in some examples, includes generating control data for a control system of an autonomous vehicle. Controlling the operation includes providing, in some examples, control data to a control system of an autonomous vehicle. Controlling the operation can include transmitting control data to, e.g., a control system of an autonomous vehicle and/or an external system. Controlling the operation can include controlling, based on control data, a control system of an autonomous vehicle and/or an external system.

The system 500 may be particularly advantageous for L0-L5 automation vehicles. For example, the system 500 provides guidance to drivers and/or passengers with no automation in an L0 vehicle. For driver assistance, L1, partial automation, L2, vehicles, conditional automation, L3, vehicles, high automation, L4, vehicles, and full autonomation, L5, vehicles, the system 500, in some examples, provides guidance to drivers and/or passengers and also operates the autonomous vehicle, either fully or partly.

Referring now to FIG. 7, illustrated is a flowchart of a method or process 800 for systems and methods for heads-up display, such as for operating and/or controlling an autonomous vehicle and/or a non-autonomous vehicle. The method can be performed by a system disclosed herein, such as an AV compute 400 of FIG. 4 or AV compute 202f of FIG. 2, and a vehicle 102, 200, of FIGS. 1 and 2. The method can be performed by a system disclosed herein, such as a compute 540 of FIGS. 5A-5D and implementations of FIGS. 6A-6B. The method can be performed by a system, such as a compute, of a vehicle that is not an autonomous vehicle. The system disclosed can include at least one processor which can be configured to carry out one or more of the operations of method 800. The method 800 can be performed (e.g., completely, partially, and/or the like) by another device or group of devices separate from or including system disclosed herein.

A method 800 is disclosed. The method 800 includes obtaining, at step S802, using at least one processor, sensor data associated with an environment in which a vehicle is operating. The method 800 includes determining, at step S804, using the at least one processor, based on the sensor data, a plurality of trajectories for the vehicle. The method 800 includes evaluating, at step S806, using the at least one processor, based on a rule parameter, a score of a trajectory of the plurality of trajectories, wherein the rule parameter is indicative of one or more rules for operating the vehicle. The method 800 includes generating, at step S808, using the at least one processor, based on the score, trajectory data associated with a candidate trajectory of the plurality of trajectories. The method 800 includes causing, at step S810, using the at least one processor, a device to provide an output, to a user associated with the vehicle, based on the trajectory data associated with the candidate trajectory. In one or more embodiments or examples, the plurality of trajectories are candidate trajectories that a driver might choose at the current point in time.

The one or more rules of the road can be rules of passenger comfort and/or rules of expression. This includes, for example, legal and/or customary rules. Examples include areas which should not be driven on, whether or not lane changes are allowed, whether or not overtaking is allowed, where stopping, standing, or parking is allowed, whether the driver needs to yield to cross-traffic, and speed limits. The score can be used to evaluate one or more of the safety and the legality of the plurality of trajectories, such as for each trajectory of the plurality of trajectories.

The candidate trajectory may be seen as an allowable potential trajectory, which has been evaluated against the rule(s) indicated by the rule parameter. The trajectory data can include any data associated with the candidate trajectory, such as a delineation of areas that are not legal for the trajectory. As for causing a device to provide output, this can be to a driver and/or a passenger of the vehicle. The output can inform the user if some potential paths are not legal or rated poorly for particular reasons, such as safety.

In one or more embodiments or examples, causing, at step S810, the device to provide the output, to the user, based on the trajectory data includes causing the device to display a user interface object representative of the trajectory data to the user. The user interface object is, for example, one or more of an icon, a notification, shading, colors, legality, and percentages. In one or more embodiments or examples, the device is one or more of: a display device, an augmented reality device, a user device, and a projection device. In one or more embodiments or examples, causing, at step S810, the device to provide the output, to the user, based on the trajectory data includes projecting the user interface object on a surface. The device can be a mobile phone of a user of the vehicle, or the vehicle itself. In one or more embodiments or examples, the surface is one or more of a windshield of the vehicle, and a dashboard of the vehicle. The surface can be a surface in a field of view of the user, for example a windshield. In one or more examples, the surfaces extends out of the dashboard (e.g. where the projection is onto an element (e.g. a piece of glass) attached to the dashboard, etc.). In one or more embodiments or examples, causing, at step S810, the device to provide the output, to the user, based on the trajectory data includes causing the device to display a second user interface object representative of one of the plurality of trajectories to the user. In one or more embodiments or examples, causing, at step S810, the device to provide the output, to the user, based on the trajectory data includes causing the device to generate an audible signal based on an audio message associated with the trajectory data.

In one or more embodiments or examples, generating, at step S808, the trajectory data includes generating, based on the score and the sensor data, the trajectory data. In one or more embodiments or examples, the user interface object includes a color-coded user interface object and/or a pictogram. The color-coded user interface object can be semantic and/or a delineation of areas. The pictogram can be a representation of the environment. In one or more embodiments or examples, determining, at step S804, the plurality of trajectories includes determining the plurality of trajectories every 30 seconds or less.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Disclosed are non-transitory computer readable media comprising instructions stored thereon that, when executed by at least one processor, cause the at least one processor to carry out operations according to one or more of the methods disclosed herein.

Also disclosed are methods, non-transitory computer readable media, and systems according to any of the following items:

Item 1. A method comprising:
obtaining, using at least one processor, sensor data associated with an environment in which a vehicle is operating;
determining, using the at least one processor, based on the sensor data, a plurality of trajectories for the vehicle;
evaluating, using the at least one processor, based on a rule parameter, a score of a trajectory of the plurality of trajectories, wherein the rule parameter is indicative of one or more rules for operating the vehicle;
generating, using the at least one processor, based on the score, trajectory data associated with a candidate trajectory of the plurality of trajectories; and
causing, using the at least one processor, a device to provide an output, to a user associated with the vehicle, based on the trajectory data associated with the candidate trajectory.

Item 2. The method of item 1, wherein causing the device to provide the output, to the user, based on the trajectory data comprises:
causing the device to display a user interface object representative of the trajectory data to the user.

Item 3. The method of item 2, wherein the device is one or more of: a display device, an augmented reality device, a user device, and a projection device.

Item 4. The method of any of items 2-3, wherein causing the device to provide the output, to the user, based on the trajectory data comprises:
projecting the user interface object on a surface.

Item 5. The method of item 4, wherein the surface is one or more of a windshield of the vehicle, and a dashboard of the vehicle.

Item 6. The method of any of items 2-5, wherein causing the device to provide the output, to the user, based on the trajectory data comprises:
causing the device to display a second user interface object representative of one of the plurality of trajectories to the user.

Item 7. The method of any of the previous items, wherein causing the device to provide the output, to the user, based on the trajectory data comprises:
causing the device to generate an audible signal based on an audio message associated with the trajectory data.

Item 8. The method of any of the previous items, wherein generating the trajectory data comprises generating, based on the score and the sensor data, the trajectory data.

Item 9. The method of any of items 2-8, wherein the user interface object comprises a color-coded user interface object and/or a pictogram.

Item 10. The method of any of the previous items, wherein determining the plurality of trajectories comprises determining the plurality of trajectories every 30 seconds or less.

Item 11. A non-transitory computer readable medium comprising instructions stored thereon that, when executed by at least one processor, cause the at least one processor to carry out operations comprising:
obtaining sensor data associated with an environment in which a vehicle is operating;
determining based on the sensor data, a plurality of trajectories for the vehicle;
evaluating based on a rule parameter, a score of a trajectory of the plurality of trajectories, wherein the rule parameter is indicative of one or more rules for operating the vehicle;
generating based on the score, trajectory data associated with a candidate trajectory of the plurality of trajectories; and
causing a device to provide an output, to a user associated with the vehicle, based on the trajectory data associated with the candidate trajectory.

Item 12. The non-transitory computer readable medium of item 11, wherein causing the device to provide the output, to the user, based on the trajectory data comprises:
causing the device to display a user interface object representative of the trajectory data to the user.

Item 13. The non-transitory computer readable medium of item 12, wherein the device is one or more of: a display device, an augmented reality device, a user device, and a projection device.

Item 14. The non-transitory computer readable medium of any of items 12-13, wherein causing the device to provide the output, to the user, based on the trajectory data comprises:
projecting the user interface object on a surface.

Item 15. The non-transitory computer readable medium of item 14, wherein the surface is one or more of a windshield of the vehicle, and a dashboard of the vehicle.

Item 16. The non-transitory computer readable medium of any of items 12-15, wherein causing the device to provide the output, to the user, based on the trajectory data comprises:
causing the device to display a second user interface object representative of one of the plurality of trajectories to the user.

Item 17. The non-transitory computer readable medium of any of items 11-16, wherein causing the device to provide the output, to the user, based on the trajectory data comprises:
causing the device to generate an audible signal based on an audio message associated with the trajectory data.

Item 18. The non-transitory computer readable medium of any of items 11-17, wherein generating the trajectory data comprises generating, based on the score and the sensor data, the trajectory data.

Item 19. The non-transitory computer readable medium of any of items 12-18, wherein the user interface object comprises a color-coded user interface object and/or a pictogram.

Item 20. The non-transitory computer readable medium of any of items 11-19, wherein determining the plurality of trajectories comprises determining the plurality of trajectories every 30 seconds or less.

Item 21. A system, comprising at least one processor; and at least one memory storing instructions thereon that, when executed by the at least one processor, cause the at least one processor to perform operations comprising:
obtaining sensor data associated with an environment in which a vehicle is operating;
determining based on the sensor data, a plurality of trajectories for the vehicle;
evaluating based on a rule parameter, a score of a trajectory of the plurality of trajectories, wherein the rule parameter is indicative of one or more rules for operating the vehicle;
generating based on the score, trajectory data associated with a candidate trajectory of the plurality of trajectories; and
causing a device to provide an output, to a user associated with the vehicle, based on the trajectory data associated with the candidate trajectory.

Item 22. The system of item 21, wherein causing the device to provide the output, to the user, based on the trajectory data comprises:
causing the device to display a user interface object representative of the trajectory data to the user.

Item 23. The system of item 22, wherein the device is one or more of: a display device, an augmented reality device, a user device, and a projection device.

Item 24. The system of any of items 22-23, wherein causing the device to provide the output, to the user, based on the trajectory data comprises:
projecting the user interface object on a surface.

Item 25. The system of item 24, wherein the surface is one or more of a windshield of the vehicle, and a dashboard of the vehicle.

Item 26. The system of any of items 22-25, wherein causing the device to provide the output, to the user, based on the trajectory data comprises:
causing the device to display a second user interface object representative of one of the plurality of trajectories to the user.

Item 27. The system of any of items 21-26, wherein causing the device to provide the output, to the user, based on the trajectory data comprises:
causing the device to generate an audible signal based on an audio message associated with the trajectory data.

Item 28. The system of any of items 21-27, wherein generating the trajectory data comprises generating, based on the score and the sensor data, the trajectory data.

Item 29. The system of any of items 22-28, wherein the user interface object comprises a color-coded user interface object and/or a pictogram.

Item 30. The system of any of items 21-29, wherein determining the plurality of trajectories comprises determining the plurality of trajectories every 30 seconds or less.

1. A method, comprising:
obtaining, using at least one processor, sensor data associated with an environment in which a vehicle is operating;
determining, using the at least one processor, based on the sensor data, a first plurality of trajectories for the vehicle;
generating, using the at least one processor, based on a rule parameter, a score for each of a second plurality of trajectories, wherein the rule parameter is indicative of one or more rules for operating the vehicle, wherein the second plurality of trajectories comprises at least a subset of the first plurality of trajectories;
generating, using the at least one processor, based on the plurality of scores, a plurality of trajectory user interface objects corresponding to the second plurality of trajectories; and
causing, using the at least one processor, a display device to display the plurality of trajectory user interface objects, wherein each of the displayed plurality of trajectory user interface objects depicts a respective trajectory of the second plurality of trajectories and indicates the score of the respective trajectory.

2. (canceled)

3. The method of claim 1, wherein the display device at least one of: an augmented reality device, or a projection device.

4. The method of claim 1, wherein causing the display device to display the plurality of trajectory user interface objects comprises causing the display device to project the plurality of trajectory user interface objects onto a surface.

5. The method of claim 4, wherein the surface comprises at least one of a windshield of the vehicle or a dashboard of the vehicle.

6. (canceled)

7. The method of claim 1, further comprising causing the display device to generate an audible signal based on an audio message associated with at least one trajectory of the second plurality of trajectories.

8. (canceled)

9. The method of claim 1, wherein the displayed plurality of trajectory user interface objects are color-coded and/or comprise a pictogram.

10. The method of claim 1, wherein determining the first plurality of trajectories comprises determining the first plurality of trajectories at thirty second increments.

11. A system, comprising at least one processor and at least one memory storing instructions thereon that, when executed by the at least one processor, cause the at least one processor to perform operations comprising:
obtaining sensor data associated with an environment in which a vehicle is operating;
determining based on the sensor data, a first plurality of trajectories for the vehicle;
generating based on a rule parameter, a score for each of a second plurality of trajectories, wherein the rule parameter is indicative of one or more rules for operating the vehicle, wherein the second plurality of trajectories comprises at least a subset of the first plurality of trajectories;
generating based on the plurality of scores, a plurality of trajectory user interface objects corresponding to the second plurality of trajectories; and
causing a display device to display the plurality of trajectory user interface objects, wherein each of the displayed plurality of trajectory user interface objects depicts a respective trajectory of the second plurality of trajectories and indicates the score of the respective trajectory.

12. (canceled)

13. The system of claim 11, wherein the display device comprises at least one of an augmented reality device or a projection device.

14. The system of claim 11, wherein causing the display device to display the plurality of trajectory user interface objects comprises causing the display device to project the plurality of trajectory user interface objects on a surface.

15. The system of claim 14, wherein the surface comprises at least one of a windshield of the vehicle or a dashboard of the vehicle.

16. (canceled)

17. The system of claim 11, wherein the operations further comprise causing the display device to generate an audible signal based on an audio message associated with at least one trajectory of the second plurality of trajectories.

18. (canceled)

19. The system of claim 11, wherein determining the first plurality of trajectories comprises determining the first plurality of trajectories at thirty second increments.

20. A non-transitory computer readable medium comprising instructions stored thereon that, when executed by at least one processor, cause the at least one processor to carry out operations comprising:
obtaining sensor data associated with an environment in which a vehicle is operating;
determining based on the sensor data, a first plurality of trajectories for the vehicle;
generating based on a rule parameter, a score for each of a second plurality of trajectories, wherein the rule parameter is indicative of one or more rules for operating the vehicle, wherein the second plurality of trajectories comprises at least a subset of the first plurality of trajectories;
generating based on the plurality of scores, a plurality of trajectory user interface objects corresponding to the second plurality of trajectories; and
causing a display device to display the plurality of trajectory user interface objects, wherein each of the displayed plurality of trajectory user interface objects depicts a respective trajectory of the second plurality of trajectories and indicates the score of the respective trajectory.
